(19) United States
(12) Patent Application Publication
(10) Pub. No.: US 2026/0299310 A1
(43) Pub. Date: Oct. 1, 2026

(54) Spectrally Shaped Light Source

(71) Applicants: Hamamatsu Photonics K.K., Shizuoka (JP); Energetiq Technology, Inc., Wilmington, MA (US)

(72) Inventors: Qingsong Wang, Lexington, MA (US); Kosuke Saito, Hamamatsu-Shi (JP); Alexander Cutler, Hopkinton, MA (US); Jonathan P. Murray, Chelmsford, MA (US); Donald L. McDaniel, North Andover, MA (US); Huiling Zhu, Lexington, MA (US)

(73) Assignees: Hamamatsu Photonics K.K., Shizuoka (JP); Energetiq Technology, Inc., Wilmington, MA (US)

(21) Appl. No.: 19/704,077

(22) Filed: Jun. 10, 2026

Related U.S. Application Data
(62) Division of application No. 17/577,168, filed on Jan. 17, 2022, now Pat. No. 12,674,995.
(60) Provisional application No. 63/140,145, filed on Jan. 21, 2021.

(51) Int. Cl. G02B 27/10; G02B 26/00

(52) U.S. Cl. CPC G02B 27/1006; G02B 26/007

(57) ABSTRACT

A spectrally-shaped source includes a source that generates a round beam. An optical element transforms the round beam to a rectangular beam. An image forming dispersive device angularly disperses wavelengths and images the rectangular beam at a modulation plane. A pixelated SLM is illuminated by the dispersed wavelengths of the rectangular beam such that each column of illuminated pixels is illuminated by a different wavelength. Toroidal optics projects light directed from the SLM to an output plane and focuses the angularly dispersed wavelengths of the beam so that a selected portion of the optical beam is reflected toward the toroidal optic by the SLM. A controller instructs the pixelated SLM to selectively reflect the portion of the optical beam toward the toroidal optic and to selectively reflect another portion of the beam away from the toroidal optic so as to provide a desired spectral shape.

### CROSS REFERENCE TO RELATED APPLICATIONS SECTION

This application is a non-provisional of U.S. Provisional Patent Application Serial No. 63/140,145, filed on Jan. 21, 2021, entitled “Spectrally Shaped Light Source”. The entire contents of U.S. Provisional Patent Application Serial No. 63/140,145 are herein incorporated by reference.

### INTRODUCTION

Numerous commercial and academic applications have need for high brightness light over a broad wavelength range. For example, laser-driven light sources are available that provide high brightness over spectral ranges from the extreme UV through visible and into the infrared regions of the spectrum with high reliability and long lifetimes. Various types of such high-brightness light sources are commercially available from Energetiq, a Hamamatsu Company, located in Wilmington, MA.

The widespread availability of high-brightness light sources, together with growing applications that use high brightness light, has driven the need for systems that shape the spectrum of the optical output of the high-brightness light source. Spectral shaping systems are needed that can provide, for example, specific wavelength distributions. This includes systems that can provide nearly arbitrary shapes of the output spectrum from UV to infrared and also enable programmable and controllable wavelength spectrums of light at an output.

### SUMMARY

The present teaching relates to spectrally shaped sources that shape the spectrum of light generated by a high-intensity broadband light source to provide a high-brightness output optical illumination with a desired spectrum. More specifically, the present teaching relates to various embodiments of a high-intensity broadband light source that produce a round-shaped optical beam that is transformed by an input optical element into a rectangular shaped optical beam. An imaging dispersive optical element angularly disperses the wavelengths of the rectangular optical beam in one dimension and images the rectangular optical beam to illuminate a pixelated Spatial Light Modulator (SLM). Selective reflection of the pixelated spatial light modulator illuminated by the dispersed imaged optical beam produces various desired intensities of spectral output in a particular reflected direction towards a toroidal mirror.

In some embodiments of apparatus according to the present teaching, each column of an array of pixels in the pixelated spatial light modulator is illuminated at the same height by a different wavelength in the optical beam. Each column of the array of pixels in the spatial light modulator array that is illuminated is controlled to selectively reflect a desired portion of the light illuminating each column to the toroidal mirror. The toroidal mirror serves to simultaneously focus in the dispersion direction and image the rectangular shaped optical beam at an output plane. This action of the toroidal optic results in the selected portions of the dispersed wavelengths that are reflected toward the toroidal optic being overlapped in an image of the rectangular shape at an output port of the spectrally shaped source, and thus provides output optical illumination comprising a desired spectrum at the output port.

One feature of the spectrally shaped source of the present teaching is that it exhibits very high optical efficiency and can be constructed to be easy to assemble and physically compact. In addition, the spectrally shaped source generates a desired output spectrum that has high resolution and high precision and accuracy. More specifically, the use of a transformed rectangular shape optical beam of the present teaching has at least three key advantages over known systems. First, it improves a resolution of the spectral selectivity of the spectral shaper, much like a slit is used to improve a resolution of a spectrometer. Second, the rectangular shape simplifies the operation of the pixelated spatial light modulator because the modulator is illuminated by rectangular shaped images of the input beam that are separated in wavelength by the dispersive device. Thus, only a height of the illuminated columns of the array needs to be determined to provide a desired intensity of a reflected portion of an optical beam of a given wavelength. Third, the rectangular shape improves the integrity of the provided spectral profile because each reflected portion of a particular wavelength in the spectrum is independent of another reflected portion. In various embodiments, different lengths and positions for the selected portion of the pixel column that are chosen to reflect the optical illumination are used.

The spectrally shaped source of the present teaching includes optical elements positioned so as to support appropriate orientation and position of the various input and output planes as well as the plane of the spatial light modulator for various features, such as compact design, ease of assembly, high resolution, high precision, and high accuracy of spectral output. Various shapes and numbers of pixels, in one or more columns, can be controlled to reflect the portion of the optical beam to the toroidal optic to provide tailoring of the spectrum of the output illumination. Also, a spectral extension source can be optionally coupled to the output of the spectrally shaped source to expand the output spectrum wavelength range of the optical signal. The spectral extension source can be a light emitting diode (LED). The spectral extension source can also be a NIR LED. In addition, a fiber bundle can be used to transform the optical beam shape to provide a highly accurate beam shape with low loss. In addition, optical elements are positioned such that the toroidal optics configuration accommodates “off-axis” mirrors, i.e. 45-degree axis, for Digital Light Processing (DLP) micro-mirror embodiments. Furthermore, various techniques can be employed to provide stray light suppression.

### BRIEF DESCRIPTION OF THE DRAWINGS

The present teaching, in accordance with preferred and exemplary embodiments, together with further advantages thereof, is more particularly described in the following detailed description, taken in conjunction with the accompanying drawings. The skilled person in the art will understand that the drawings, described below, are for illustration purposes only. The drawings are not necessarily to scale; emphasis instead generally being placed upon illustrating principles of the teaching. The drawings are not intended to limit the scope of the Applicant’s teaching in any way.

FIG. 1 illustrates a system diagram of an embodiment of a spectrally shaped light source according to the present teaching.

FIG. 2A illustrates a schematic of an embodiment of the input optics and light source for a spectrally shaped source according to the present teaching.

FIG. 2B illustrates an input cross section of an embodiment of a fiber bundle for a spectrally shaped source according to the present teaching.

FIG. 2C illustrates an output cross section of an embodiment of a fiber bundle for a spectrally shaped source according to the present teaching.

FIG. 3 illustrates a perspective view of an embodiment of part of the spectral shaper system that includes the input fiber plane, image forming dispersive device, and spatial light modulator plane of a spectrally shaped source according to the present teaching.

FIG. 4 illustrates another perspective view of the embodiment of the spectral shaper system that includes the input fiber plane, image forming grating, and spatial light modulator plane of the spectrally shaped source of FIG. 3.

FIG. 5 illustrates another perspective view of the embodiment of the spectral shaper system that includes the input fiber plane, image forming grating, spatial light modulator plane, toroidal mirror, and output optics of the spectrally shaped source of FIG. 3.

FIG. 6 illustrates another perspective view of the embodiment of the spectral shaper system including the input fiber plane, image forming grating, spatial light modulator plane, toroidal mirror and output optics of the spectrally shaped source of FIG. 3 that illustrates the input.

FIG. 7A illustrates a perspective view of an embodiment of the input planes, image forming dispersive device, and spatial light modulator plane of a spectral shaper system for an infrared-extended spectrally shaped source according to the present teaching.

FIG. 7B illustrates another perspective view of the embodiment of the spectral shaper system for an infrared-extended spectrally shaped source of FIG. 7A.

FIG. 7C illustrates yet another perspective view of the embodiment of the spectral shaper system for an infrared-extended spectrally shaped source of FIG. 7A.

FIG. 8A illustrates the illumination of a modulator showing the light from the visible spectrum and the NIR spectrum of a spectral shaper of the present teaching.

FIG. 8B illustrates the illumination of modulator regions of visible and NIR light from a face-on view of the system of FIG. 8A.

FIG. 9A illustrates a simulation of the spatial distribution of an output beam spot in the near-infrared region of the spectrum of an embodiment of the spatial shaper system of the present teaching.

FIG. 9B illustrates a simulation of the spatial distribution of an output beam spot in the visible region of the spectrum of an embodiment of the spatial shaper system of the present teaching.

FIG. 9C illustrates a simulation of the composite spatial distribution of an output beam spot in the near-infrared and visible regions of the spectrum of the embodiment of the spatial shaper system of FIGS. 9A and 9B.

FIG. 10A illustrates results of a model of the modulator plane in an embodiment of a near-IR extended spectral shaper of the present teaching.

FIG. 10B illustrates photographs of the modulator plane for two measurements of embodiments of a near-IR extended spectral shaper of the present teaching.

FIG. 11A illustrates a graph of spectra from an embodiment of the spectral shaper of the present teaching with particular rows of mirrors configured in the “on state” and showing a comparison of the visible spectrum and the NIR spectrum.

FIG. 11B illustrates a graph of spectra from the embodiment of the spectral shaper system of FIG. 11A showing the output with all the mirrors in the “on state” for the visible spectrum and/or the NIR spectrum.

FIG. 12A illustrates a graph of a spectrum from an embodiment of the spectral shaper system of the present teaching with particular rows of mirrors in the visible region in the on state.

FIG. 12B illustrates a graph of a spectrum from an embodiment of the spectral shaper system of the present teaching with particular rows of mirrors in the NIR region in the on state.

FIG. 12C illustrates a graph of the spectra of FIGS. 12A and 12B on a shared axis.

FIG. 13A illustrates a graph of a spectrum from an embodiment of the spectral shaper system of the present teaching with five peaks in the NIR region using five rows of mirrors in the NIR region in the on state.

FIG. 13B illustrates a graph of the spectrum of FIG. 13A with calculated FWHM information.

FIG. 14A illustrates a front view of an optical source that generates visible light and NIR optical light from a broadband point source of light.

FIG. 14B illustrates a top view of the optical source of FIG. 14A that generates visible light and NIR optical light.

FIG. 14C illustrates a side top view of the optical source of FIG. 14A that generates visible light and NIR optical light.

FIG. 15 illustrates a graph of spectra of the output for different embodiments of the optical source for a spectral shaper system according to present teaching that use different filters and/or mirror coatings on the optical elements and a Xenon-based high-brightness plasma to generate the point source illumination.

FIG. 16 illustrates an alignment and characterization system for an optical source for the spectral shaper system of the present teaching.

### DESCRIPTION OF VARIOUS EMBODIMENTS

The present teaching will now be described in more detail with reference to exemplary embodiments thereof as shown in the accompanying drawings. While the present teaching is described in conjunction with various embodiments and examples, it is not intended that the present teaching be limited to such embodiments. On the contrary, the present teaching encompasses various alternatives, modifications and equivalents, as will be appreciated by those of skill in the art. Those of ordinary skill in the art having access to the teaching herein will recognize additional implementations, modifications, and embodiments, as well as other fields of use, which are within the scope of the present disclosure as described herein.

Reference in the specification to “one embodiment” or “an embodiment” means that a particular feature, structure, or characteristic described in connection with the embodiment is included in at least one embodiment of the teaching. The appearances of the phrase “in one embodiment” in various places in the specification are not necessarily all referring to the same embodiment.

It should be understood that the individual steps of the method of the present teaching can be performed in any order and/or simultaneously as long as the teaching remains operable. Furthermore, it should be understood that the apparatus and method of the present teaching can include any number or all of the described embodiments as long as the teaching remains operable.

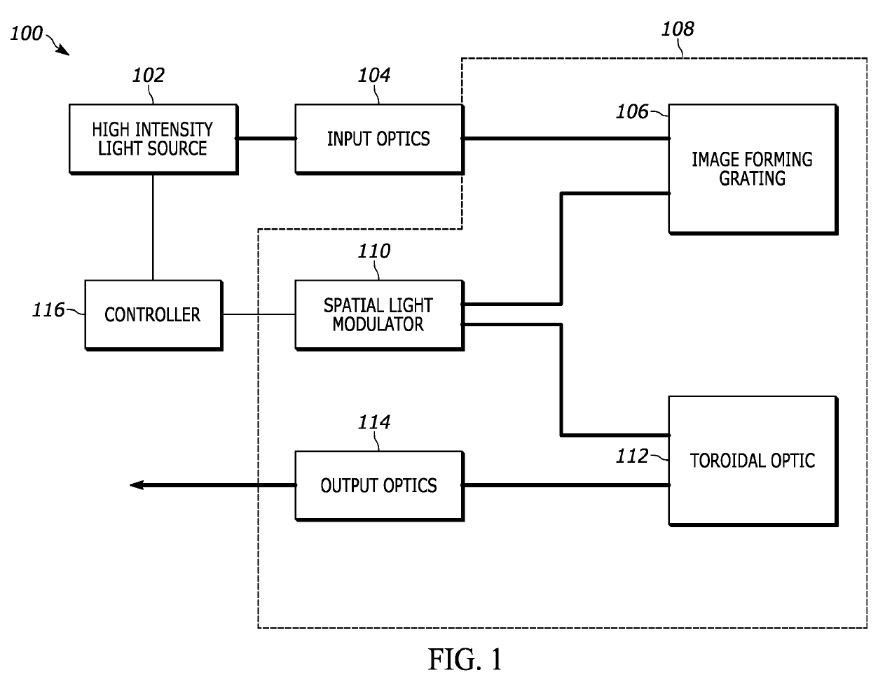

FIG. 1 illustrates a system diagram of an embodiment of a spectrally shaped source 100 according to the present teaching. A high intensity optical source 102 produces high-brightness light at an output. The optical source 102 can be, for example, a high-brightness laser driven light source (LDLS), such as a laser driven xenon lamp, that provides broadband light supplied by a high-intensity plasma at an output. The source 102 can also be, for example, a super continuum fiber laser.

The output light is collected by input optics 104 and directed to an image forming grating 106. The image forming grating 106 in some embodiments is an image forming dispersive device. The input optics 104 can include various optical elements including, for example, bulk optical components and/or fiber optic components. The input optics 104 can transform the spatial output of the light from the source 102 into a desired spatial profile at an input plane of the spectral shaper system 108. The image forming grating spatially separates the wavelengths of the light from the input and directs the light to a spatial light modulator 110.

The spatial light modulator 110 modulates the light in the spatially separated wavelengths of light independently and directs them to a toroidal optic element 112. In some embodiments, the spatial light modulator is a pixelated spatial light modulator. In some embodiments the pixels form a one-dimensional array. In some embodiments, the pixels form a two-dimensional array. In some embodiments, the pixelated spatial light modulator 110 comprises a digital micro-mirror device (DMD). In some embodiments, the pixelated spatial light modulator comprises a liquid crystal on silicon (LCOS) device. Also, in some embodiments, the pixelated spatial light modulator 110 includes an order-sorting filter that increases spectral purity.

The toroidal optic element 112 directs the light reflected toward the toroidal optical element 112 by the spatial light modulator 110 to output optics 114. The toroidal optic element 112 collects and focuses light from the spatial light modulator 110. Some embodiments of the toroidal optic element utilize a reflective surface with a toroidal shape that recombines the spatially separated wavelengths of light and images the light from the surface of the modulator that are directed to the toroidal optic to an output plane. The output optics 114 can include various optical elements including, for example, bulk optical components and/or fiber optic components and can be used, for example, to couple the imaged optical light into an optical fiber or other lightguide.

A controller 116 is connected to the high-intensity light source and/or the spatial light modulator 110 to control the modulation of the light to provide a desired optical spectrum at the output of the output optics 114. In some embodiments, the controller 116 operates in an open-loop configuration, and uses, for example, pre-loaded spectrum files to determine how to control the spatial light modulator. For example, the pre-loaded spectrum files can include how many pixels in a column of the modulator 110 associated with a particular wavelength are directing light toward the toroidal optical element 112. In these embodiments, no external sensor and/or spectrometer is needed to adjust the spectral profile. This feature is possible because of the precise shaping and spectral imaging of the optical beams in the system. The input beam and the image forming grating 106 are configured to illumination a precise shape and size of a region on the modulator with a particular desired wavelength. Because of the precise illumination region size and shape, the number and position of pixels illuminated by the desired wavelength in the region can be determined. A pixel in the “on state” reflects light, while a pixel in the “off state” does not reflect light. Therefore, the intensity of light reflected from the region is controlled by controlling the number of pixels in the “on state”. Thus, it is possible to produce a desired intensity of a particular wavelength at the output only by controlling the number of pixels in the “on state” in the illuminated region. In some embodiments, the size and shape of the image beam is a rectangular shape that illuminates one column of a two dimensional array of pixels in the modulator.

Various embodiments of the spectral shaper system 108 may or may not include specific input optics 104 or output optics 114, depending on the application. Some embodiments of the spectral shaper systems 108 can include an internal controller with pre-loaded control algorithms for controlling the spatial light modulator to provide desired spectral shapes of the output light.

One feature of the present teaching is that the spectrally shaped source 100 can include input optics 104 that spatially shape the high-brightness light from the optical source 102 to provide a spatial profile at an input plane of the shaper that produces a desired image at the plane of the spatial light modulator 110 after transformation by the image forming grating106. For example, in some embodiments, it is desirable that the spatial profile of light at an input plane of the shaper optical system 108 have a substantially rectangular shape. The light that emerges from the high-brightness source 102 can be, for example, generally a circular shape. Thus, in some embodiments, the input optics 104 performs a transformation from a circular shape input to a rectangular shape output.

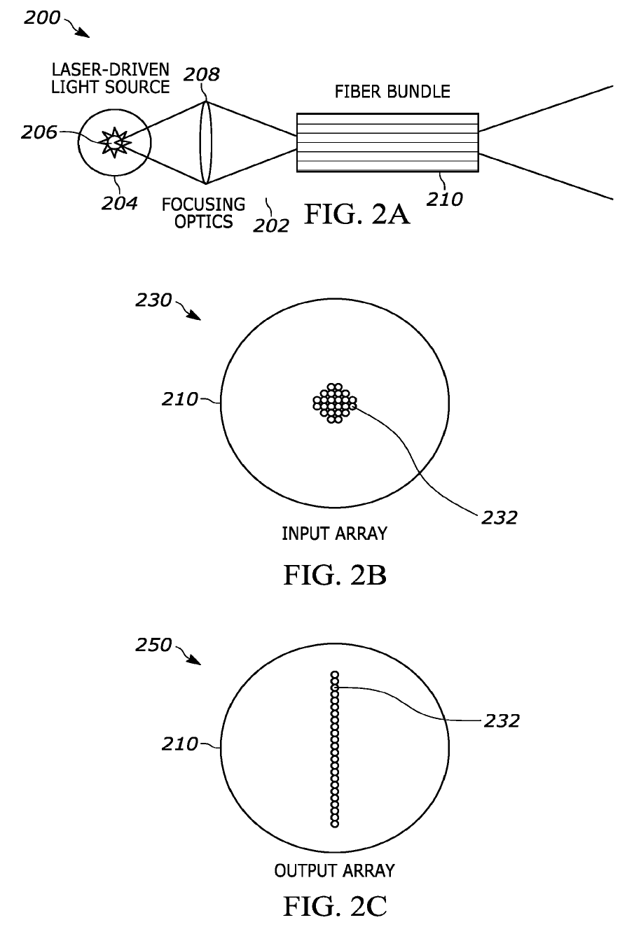

FIG. 2A illustrates a schematic of some elements 200 including the input optics 202 and light source 204 for an embodiment of a spectrally shaped source according to the present teaching. The light source 204 generates light from a high-intensity plasma 206 that diverges from the light source 204. Focusing optics 208 in the input optics 202 collect the divergent light from the light source 204 and focus the light to an input of an optical fiber bundle 210. In some embodiments, the fiber bundle 210 is configured to transform a shape of the focused beam that is coupled at the input of the fiber to a desired output shape.

FIG. 2B illustrates an input cross section 230 of an embodiment of a fiber bundle 210 for a spectrally shaped source according to the present teaching. Individual fibers 232 in the bundle are arranged in a nominally circular shape at the input.

FIG. 2C illustrates an output cross section of an embodiment of the fiber bundle 210 for a spectrally shaped source according to the present teaching. Individual fibers 232 in the bundle are arranged in a nominally rectangular shape at the input. In this embodiment, that shape is provided by a single column of 24 fibers. Other embodiments can use different aspect ratios of height-to-width of the rectangular shape and/or different numbers of fibers. The transformation from circular shape to rectangular shape is achieved by rearranging the positions of the fibers 232 over the length of the bundle 210 to realize the desired shape transformation. As understood by those skilled in the art, numerous shapes and shape transformations can be achieved using a fiber bundle. In some embodiments, a shape of an input cross-section of the fiber bundle is provided that closely matches an image of a plasma 206 or other light-generating element in the source 204. In some embodiments, a shape of the output cross-section of the fiber bundle 210 is provided that has a rectangular shape that is matched to a shape of a pixel, or group of pixels, in the spatial light modulator in the shaper system.

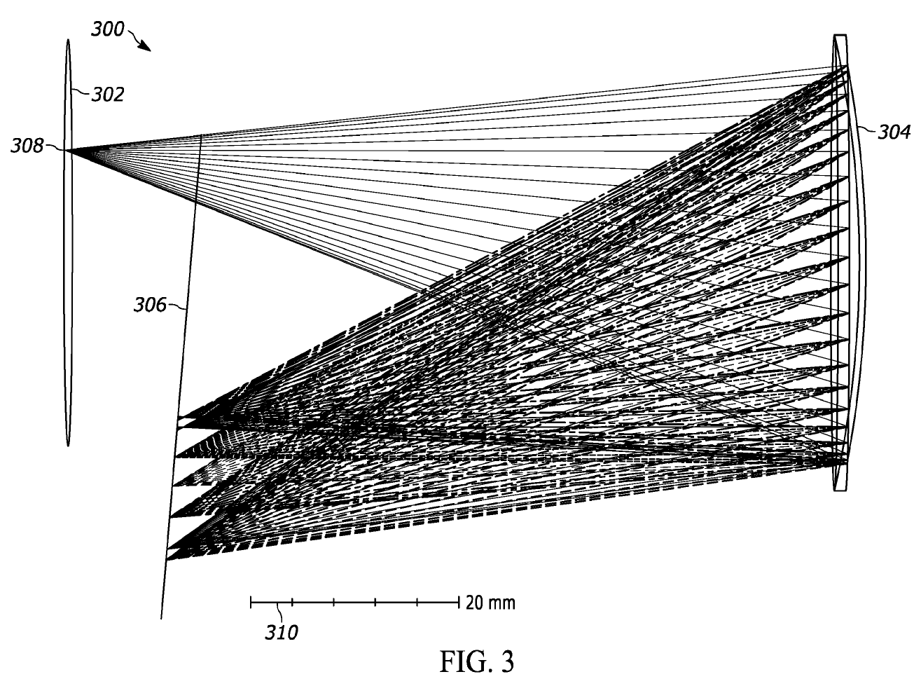

FIG. 3 illustrates a perspective view of an embodiment of part of a spectral shaper system 300 that includes the input fiber plane 302, image forming dispersive device 304, and spatial light modulator plane 306 of a spectrally shaped source according to the present teaching. A length scale 310 is indicated. This length scale 310 is exemplary and shaper systems of the present teaching are not limited to this size or shape as understood by those skilled in the art.

Input light, which can be white light or other broadband light, is introduced into the shaper as an optical beam 308 having a particular shape. The shape may be provided by passing the optical beam 308 through a fiber array. While a fiber array is described herein, other input optics can be used to provide an input optical beam 308 with a desired shape at the input plane 302. The fiber array can be, for example, a straight-line fiber-array or a rectangular array or other shape. In some embodiments, the fiber array is a straight-line fiber-array constructed from a multi-strand fiber bundle with a circular input bundle cross-section and a straight-line output end. In some embodiments, the light from the array is formed in a shape of a rectangular optical beam 308.

The light in the optical beam 308 from the array is then directed to the image forming dispersive device 304 that separates the spectrum of the light in the shaped optical beam into spatially separated beams. Thus, the image forming dispersive device 304 angularly disperses wavelengths of the optical beam in a dispersion direction and images the shape of the optical beam at a modulation plane 306. In some configurations according to the present teaching, the optical beam is formed in a rectangular shape. In some embodiments, the image forming dispersive device 304 is a concave, aberration-corrected, image-forming grating. The use of a curved dispersive element to image the input optical beam can eliminate the need for an extra optical element, such as a lens, needed in the shaper system to perform the imaging.

The image forming dispersive device 304 produces an image of the fiber-array 308 output at the input plane 302 onto a surface of a spatial light modulator (not shown) positioned in a modulator plane 306. Different wavelengths of light separated by the dispersive device 304 are separately imaged onto different modulator regions. In some configurations according to the present teaching, the input light is a rectangle shape, and modulator regions are columns of an array of pixels that form the modulator. For example, for an individual wavelength of input light, the dispersive element forms an image of the input light beam shape onto a specific column of a modulator.

For a broadband light input, images of the input shape at different wavelengths are formed on different columns of the pixelated modulator, forming a rainbow across the columns. In some embodiments, the modulator is a DMD modulator, and the different wavelength images coincide with different micro-mirror pixel columns. Various descriptions herein will refer to particular rows and/or columns of pixels as representing one dimension of the array without loss of generality, as the relative orientation of the array is arbitrary as understood by those skilled in the art.

In some embodiments, the input plane 302 and the modulator plane 306 are different planes, and a normal to the input plane 302 is not collinear with a normal to the modulator plane 306. This configuration assists in providing a compact three-dimensional package for the optical system, which maintains a high-quality image of the optical input shape at the modulator plane 306.

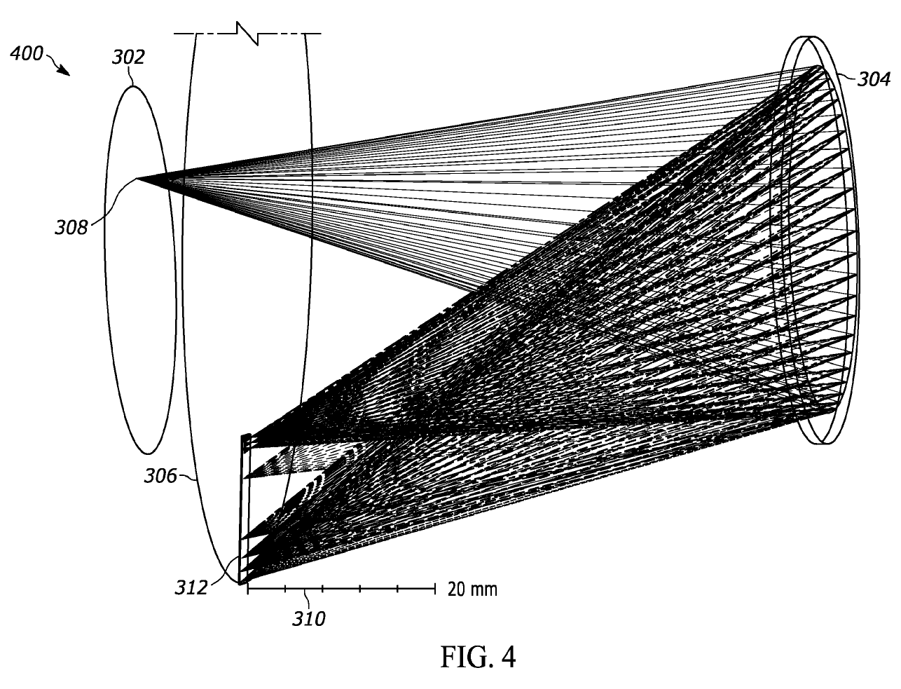

FIG. 4 illustrates another perspective view of the embodiment of the spectral shaper system 400 including the input fiber plane 302, image forming dispersive device 304, and spatial light modulator plane 306 for the spectrally shaped source of FIG. 3. The length scale 310 is also shown. The fiber array 308 and modulator 312 are shown. This view shows the three surfaces of the array, a view at the input plane 302, a view at the concave surface of the dispersive device 304 that spreads the individual wavelengths in space to form images at different wavelengths, and a view at the plane 306 of the input to the modulator 312. Each wavelength that emerges at a different angle from the dispersive device 304 forms a separate image of the input array 308 in different regions of the modulator 312 based on the wavelength separation provided by the grating and the curvature of the dispersive device 304. In some embodiments, the dispersive device 304 also provides correction for spherical aberration.

In some embodiments, an order-sorting filter is positioned in the path between the image forming dispersive device 304 and the modulator 312. The order-sorting filter can be positioned on or integrated into the image forming dispersive device 304 and/or the modulator 312. The order-sorting filter enhances the spectral purity of the spectrum in the image plane by rejecting the second order of shorter-wavelength light from mixing with the first-order light. The first and second orders have a wavelength difference of a factor of two. For example, a 400 nm second order wavelength is rejected and will not overlap with the 800 nm first order wavelength of light.

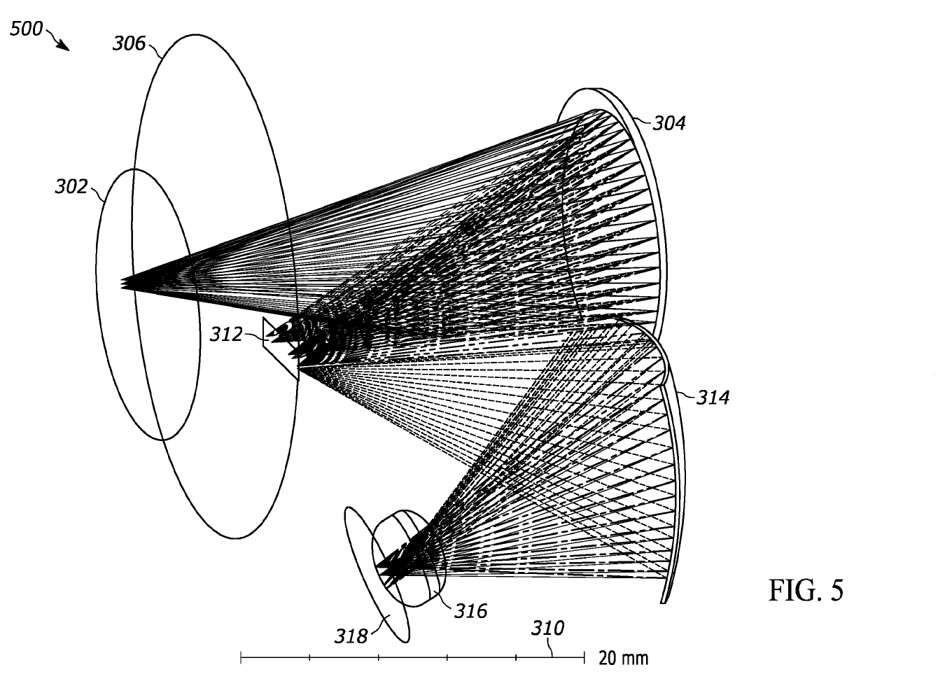

FIG. 5 illustrates another perspective view of the embodiment of the spectral shaper system 500 including the input fiber plane 302, image forming dispersive device 304, spatial light modulator plane 306, toroidal mirror 314, and output optics 316 for the spectrally shaped source of FIG. 3. The length scale 310 is also shown. The system includes the fiber array 308 and the modulator 312 shown in FIG. 4. A toroidal mirror 314 and output optics 316, which in this embodiment is a lens, are used to project the optical light directed from the modulator 312 to the toroidal mirror 314 to an output plane 318 of the shaper system 500. The modulator 312 is controlled to direct light from some regions of the modulator 312 toward the toroidal mirror 314 while directing light from other regions of the modulator 312 away from the toroidal mirror 314. For example, in some embodiments, light from one or more pixels of a DMD is directed toward the mirror 314 and light from other pixels is directed away from the mirror 314.

In some embodiments, the modulator 312 is a two-dimensional array of pixels comprising rows and columns of pixels. Light from a rectangular shaped optical beam at the input plane 312 is imaged such that a width and height of the imaged rectangle at the modulator plane 306 corresponds to a width and height of a column of pixels. The spatial separation of wavelengths by the dispersive device 304 causes different wavelengths of light to illuminate different columns of pixels. A controller (not shown in FIG. 5) is used to configure each of the pixels in the modulator 312 to direct light toward or away from the toroidal mirror 314.

The dispersive device 304 configuration determines the central wavelength and spectral bandwidth around the central wavelength, which can be referred to as a spectral segment, that is directed to each column of pixels in the modulator 312. A certain fraction of the pixels in a column are then controlled to direct the light to the mirror 314, while the remaining pixels direct light away from the mirror 314. Different columns correspond to different spectral segments of light. In this way, a controlled fraction of the intensity of light in a particular spectral segment that is directed to the mirror 314 is then reflected by the mirror 314 to the output, thereby providing a controlled intensity of light in the spectral segment at the shaper output. Because different spectral segments associated with different columns are independently controlled, this feature provides a controlled shape of the intensity as a function of wavelength at the shaper system output.

One feature of using the rectangular shape of the optical light at the input plane 302 as described is that a very low loss, or high throughput efficiency can be realized. This occurs because the image efficiently illuminates the surface of a rectangular modulator 312 so nearly all the input light impinges to a pixel and nearly all light directed by the modulator to the toroidal mirror 314 appears at the output plane 318. Also, high accuracy of intensity is provided because the pixels are uniformly illuminated. It should be understood that in various embodiments, different shapes of image from the input plane 302 to the modulator plane 306, as well as different shapes of illuminated regions on the modulator 312, are also possible.

One feature of the present teaching is that the image formed by the image forming dispersive device 304 of the rectangular shaped input optical beam illuminates the pixels in columns of the modulator 312 at a uniform height. In this case, a height of pixels in a column associated with a particular wavelength that are controlled to reflect the light from the surface of the modulator 312 toward the toroidal mirror 314 determines the fraction of the illumination in that wavelength that appears at the output. Controlling the various heights of the columns of the pixels in the modulator then provides a desired spectral shape of the illumination at the output plane 318.

Also, the amount of light reflected toward the toroidal mirror in a given wavelength band associated with a column of the spatial light modulator 312 can be determined by a number of pixels in that column that are controlled to direct light to the toroidal mirror 314. Thus, in some embodiments, a number of pixels in at least one column of pixels that is illuminated by the angularly dispersed wavelengths of the rectangular optical beam imaged by the image forming dispersive device is chosen to provide a desired spectral shape of the output optical illumination at the output plane 318.

The toroidal mirror 314 is configured with a reflective surface in a shape that spatially recombines the wavelengths from the spatial light modulator 312 that are directed to the surface of the mirror 314 and direct them to the output optics 316. The output optics 316 couple the spatially recombined light into a desired receiving optical system (not shown) positioned at an output plane 318 of the shaper system 500. The output optics 316 in some embodiments is an output lens that couples the output light directed off of the toroidal mirror 314 to a liquid light guide (not shown). Other optical systems for receiving the optical beam from the output plane 318 are also possible as can be based on a particular application.

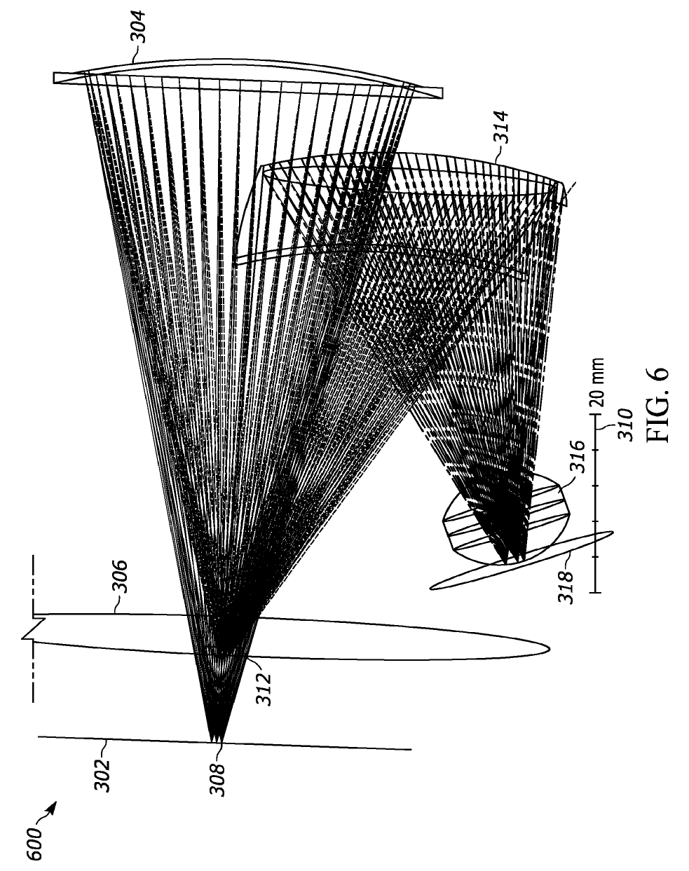

FIG. 6 illustrates another perspective view of the spectral shaper system 600 including the input fiber plane 302, image forming dispersive device 304, spatial light modulator plane 306, toroidal mirror 314, and output optics 316 of the spectrally shaped source of FIG. 3. This view of the shaper system 600 illustrates an optical axis through the input plane 302 to the dispersive device 304 and how the dispersive device 304 directs the light to the modulator plane 306 with a normal that is non-collinear with the optical axis through the input plane 302 to the dispersive element 304. This view of the shaper system 600 also shows how the toroidal mirror 314 has a three-dimensional toroidal surface shape that both spatially recombines the wavelengths that are directed toward the mirror 314 and directs them towards the output plane 318.

The embodiment of the spectral shaping system shown in FIGS. 3-6 is illustrated with the dispersive device, modulator, and toroidal optical elements configured as reflective devices. It should be understood that one or more of those elements can be configured as a transmissive device with well understood modifications to the optical system and still be consistent with a spectral shaper system of the present teaching.

One feature of the spectral shaping system of the present teaching is that it can be designed to accommodate multiple wavelength ranges of interest. For example, embodiments of the system operate over a wavelength range from ~380 nm to ~760 nm. This may be referred to as the UV and visible region of the spectrum. Embodiments of the system also operate over a wavelength range from ~380 nm to ~1100 nm. This extended wavelength range includes spectral components in the near infrared (NIR) region of the spectrum, nominally from ~760 nm to ~1100 nm.

Some embodiments of the spectral shaper according to the present teaching produce spectral shaping in the NIR region of the spectrum that share the image-forming dispersive element and modulator, but have different input configurations for the UV and/or visible light and the NIR light. These embodiments locate the shaped optical beam in the NIR region of the spectrum at a position that generates astigmatism aberrations from the image forming dispersive device, and then these aberrations are used to locate the NIR spectrum at a different position on the surface of the spatial light modulator from the visible/UV spectrum. Thus, the NIR spectral components and visible and/or UV components can be independently controlled because they illuminate different pixel columns.

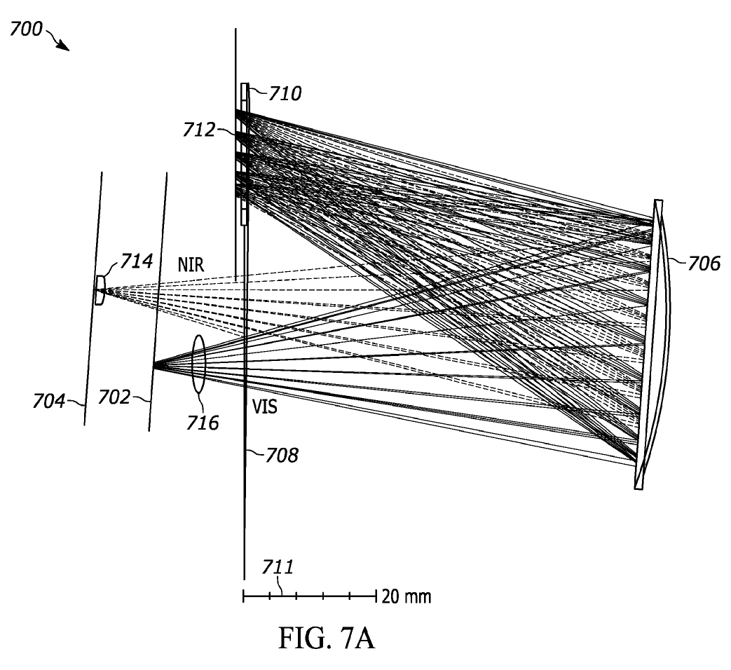

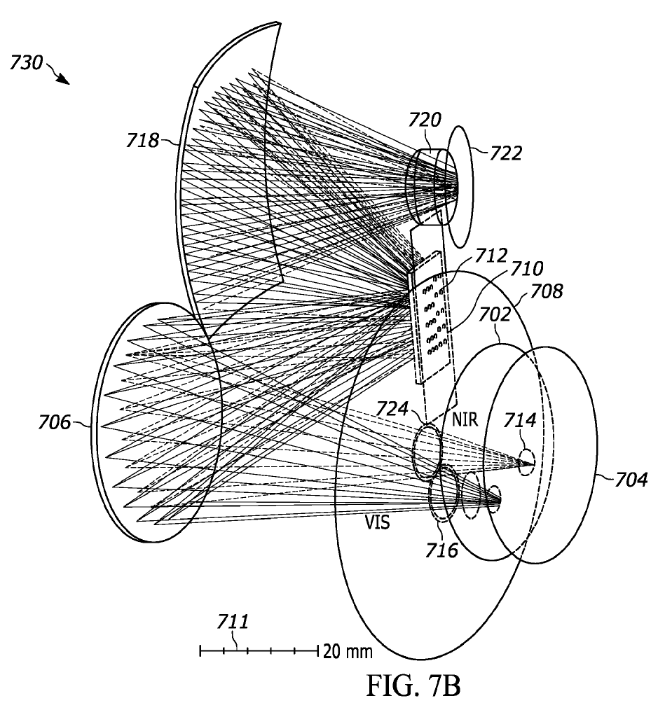

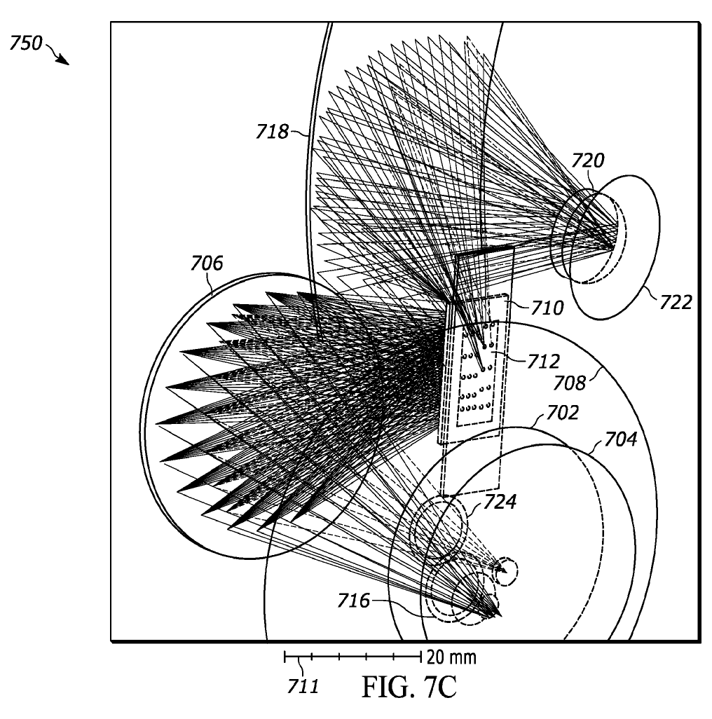

FIG. 7A illustrates a perspective view of an embodiment of a spectral shaper system 700 including the input planes 702, 704, image forming dispersive device 706, and spatial light modulator plane 708 of an infrared-extended spectrally shaped source according to the present teaching. The shaper system 700 shown in perspective view 700 has a length scale 711 indicated. This length scale 710 is exemplary and NIR-extended shaper systems of the present teaching are not limited to this size or shape as understood by those skilled in the art.

Visible and/or ultraviolet input light is introduced into the shaper system 700 as an optical beam having a rectangular shape at the visible input plane 702. In some embodiments, the visible light is a line shape. Near infrared light is input at a NIR input plane 704. In some embodiments, the NIR light is input as a point source shape. The light from the visible input plane 702 and the light from the NIR input plane 704 is directed to the image forming dispersive device 706. The image forming dispersive device 706 separates the spectrum of the light in the shaped optical beams from the NIR and visible planes 702, 704 into spatially separated beams and directs them to the spatial light modulator window 710 positioned at a spatial light modulator plane 708 such that the NIR spectrum is parallel to the visible spectrum on the modulator 712 positioned just behind the window 710. The NIR subsystem shares the same optical path with the visible system. In some embodiments, the visible light is provided by a fiber bundle with a linear array of fibers at the output cross section. This produces a line shape. In some embodiments, the NIR system is nominally a point source. This point source can be provided, for example, from a single optical fiber output.

The NIR shares this path until it is coupled into an output optical device, which may be a liquid light guide. Both of the visible and NIR spectra are located on the spatial light modulator with a spatial gap, so they can be independently manipulated by the spatial light modulator 712 and controller (not shown). In this embodiment, the NIR input is offset from an optimum input position that would have no aberration. The offset position introduces astigmatism from the image forming dispersive device 706, which serves to generate a line shape of NIR light at the spatial light modulator 712 from the point source shape of the NIR input light. The aberrations also serve to locate the NIR spectrum at a different position from the visible light on the modulator 712. In contrast, the visible input, which is a line source shape is imaged with no aberration.

Similar to the embodiment described in connection with FIG. 3, the image forming dispersive device 706 of the embodiment of FIG. 7A produces an image of the shaped optical beam at the visible input plane 702 and the NIR input plane 704 at the modulator plane 306 (FIG. 3). Different wavelengths of light separated by the dispersive device 706 are separately imaged onto different modulator pixel regions. In some embodiments, the modulator is a DMD modulator, and the different wavelength images coincide with different DMD pixel columns. In some embodiments, the input planes 702, 704 and the modulator plane 708 are different planes, providing a compact three-dimensional package for the optical system. Optionally, an optical wedge 714 can be used to project the NIR optical beam, and an optical aperture 716 can be used to aperture the visible and/or UV optical beam from the input planes 702, 704.

FIG. 7B illustrates another perspective view 730 of the spectral shaper system for an infrared-extended spectrally shaped source of FIG. 7A. The length scale 711 is shown. This view 730 shows the visible input plane 702 and the visible line source optical beam that enters the system at that plane 702. The NIR optical beam input is a point source at the NIR plane 704 that passes through the optical wedge 714. The NIR light passes an aperture 724 and the visible light also passes and aperture 716 and then both beams impinge the image-forming dispersive device 706. The image-forming dispersive device 706 spatially separates the wavelengths of light of both the visible and NIR light. The image-forming dispersive device 706 images different color points of light from the NIR light and different colored lines of light from the visible light to the spatial light modulator 712 after passing through the window 710.

A controller (not shown) is used to control the spatial light modulator 712 such that a desired amount of light from each color is directed to the toroidal mirror 718 that spatially recombines the wavelengths and directs the desired amount of light from each color to a collection lens 720. The collection lens provides an optical beam at an output plane 722 with a desired spectral shape of the output optical illumination.

FIG. 7C illustrates a portion of yet another perspective view of the spectral shaper system 750 for the infrared-extended spectrally shaped source of FIG. 7A. The visible input plane 702, NIR input plane 704, image forming dispersive device 706, spatial light modulator plane 708, spatial light modulator window 710, spatial light modulator 712, toroidal optical mirror 718, collection lens 720, and output plane 722 are shown. The scale 711 is indicated. This view of the spectral shaper system 750 illustrate the complex three-dimensional trajectories of the optical beams that pass through the system. This is why a toroidal mirror 718 is needed to both spatially recombine the wavelengths dispersed by the dispersive device 706 and to re-image the light at the output plane 722.

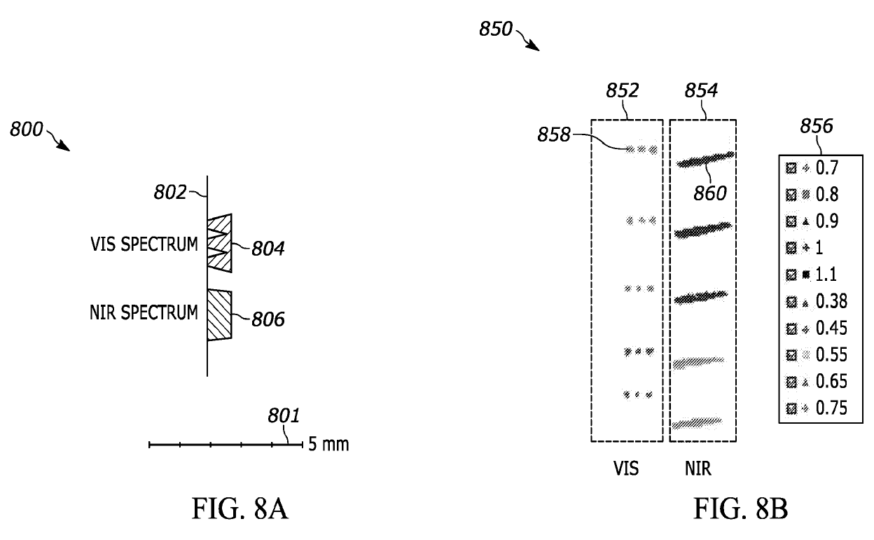

FIG. 8A illustrates the illumination 800 of a modulator 802 showing the illumination from the visible spectrum 804 and the NIR spectrum 806 of a spectral shaper system of the present teaching. A length scale 801 is provided. The light from the visible spectrum 804 and the NIR spectrum 806 share the same modulator 802. The visible light 804 impinges the top half of the modulator 802 and exhibits high resolution due to lower aberrations from the imaging dispersive device. The NIR light 806 impinges on the bottom half of the modulator 802 and exhibits lower resolution due to aberration in the imaging dispersive device. Thus, the two spectra 804, 806 are spatially separated and there is only minimal wavelength range overlap. In some embodiments, bandpass filters are used.

FIG. 8B illustrates the illumination 850 of the modulator regions 852, 856 from a face-on view of the system of FIG. 8A. A wavelength scale 856 is shown, with different wavelengths of light having different symbols and different grey scale levels in the simulation in the regions 852, 854. In the NIR spectrum region 854, for each wavelength, the spectral lines 860 are tilted and parallel with the spectral lines of other wavelengths. As a result, the output for the NIR is a line image when these lines are recombined in the toroidal mirror. The visible light 858 has higher resolution, and the input array shape is imaged on the modulator 802 and also at the output of the shaper system after being recombined in the toroidal mirror. Note that although individual circular array elements from a linear array of optical fibers provided at the input are resolved as three individual spots, such a pattern can be referred to as a line shape or a rectangular shape. Generally, in connection with the apparatus according to the present teaching, the visible spectrum 804 covers a range from ~ 380 nm to ~ 750 nm, and the NIR spectrum 806 covers a range from ~700 nm to ~1100 nm.

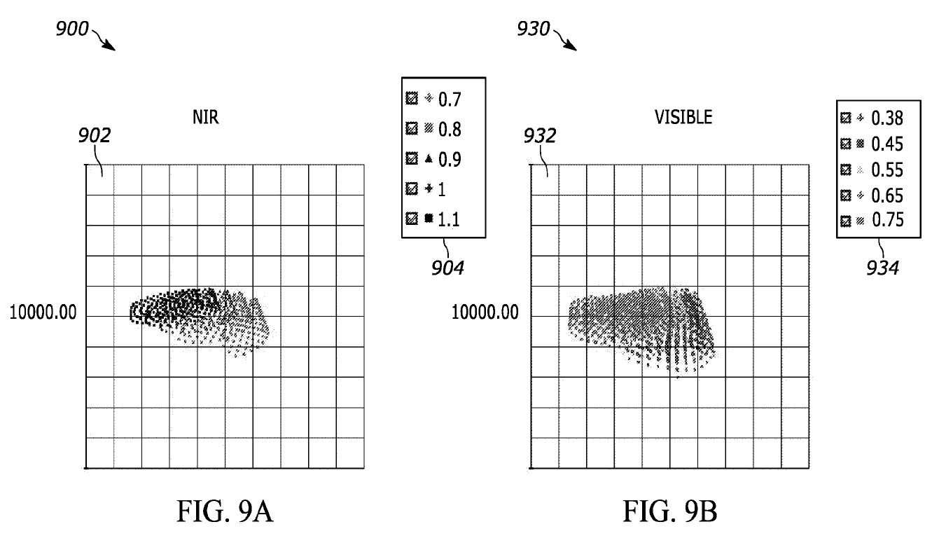

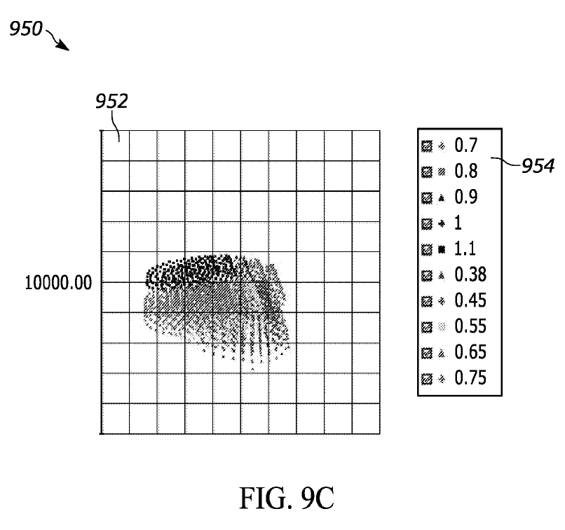

FIG. 9A illustrates a simulation of the spatial distribution 900 of an output beam spot in the near-infrared region of the spectrum of an embodiment of the spectral shaper system of the present teaching. The grid squares 902 are one-millimeter square. The legend 904 refers to the grey scale in the figure which shows different wavelengths from 0.7 micrometers to 1.1 micrometers. The spatial distribution 900 represents the spot size at the input surface to, for example, an output liquid light guide coupled to the shaper system (not shown).

FIG. 9B illustrates a simulation of the spatial distribution 930 of an output beam spot in the visible region of the spectrum of an embodiment of the spatial shaper system of the present teaching. The grid squares 932 are one-millimeter square. The legend 934 refers to the grey scale representing different wavelengths from 0.38 micrometers to 0.75 micrometers. The spatial distribution 930 represents the spot size at the input surface to, for example, an output liquid light guide coupled to the shaper (not shown).

FIG. 9C illustrates a simulation of the composite spatial distribution 950 of an output beam spot in the near-infrared and visible regions of the spectrum of the embodiment of the spatial shaper system of FIGS. 9A and 9B. The grid squares 952 are one-millimeter square. The legend 954 refers to the grey scale in the figure representing different wavelengths from 0.38 micrometers to 1.0 micrometers. The spatial distribution 950 represents the spot size at the input surface to, for example, an output liquid light guide coupled to the shaper system (not shown). This result is achieved with visible and NIR that share the same optics in the spectral shaper system. The output of the shaper system has the visible and NIR light overlapped onto a small area. The area has a dimension of approximately four millimeters by five and a half millimeters. This size and shape of a spatial distribution 950 at the output plane of the spectral shaper can be efficiently collected by a liquid light guide.

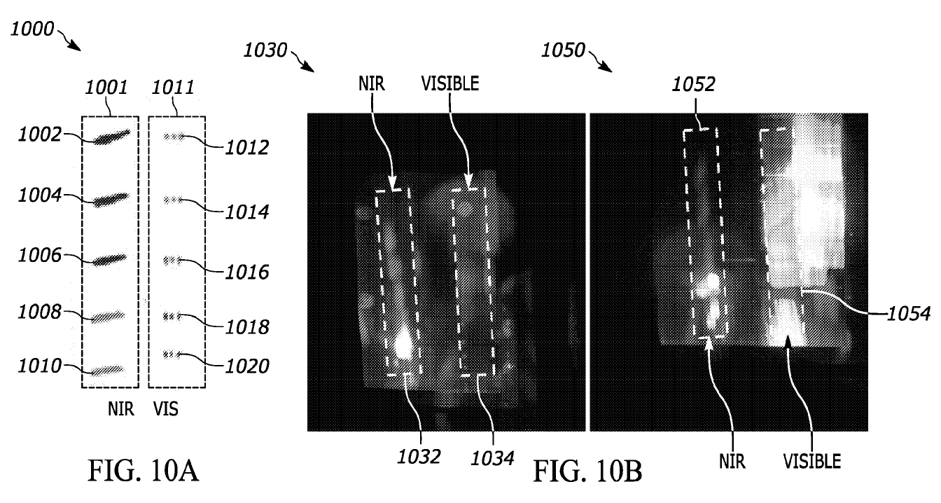

FIG. 10A illustrates the results of a ZemaxTM model simulator output 1000 of the modulator plane in an embodiment of a near-IR extended spectral shaper system of the present teaching. The NIR region 1001 of the modulator shows illumination patterns 1002, 1004, 1006, 1008, 1010 for five different individual NIR wavelengths with a line shape that is slightly tilted as a result of some aberration in the imaging dispersive element because of the offset placement of the input NIR point source at the NIR input plane. The visible region 1011 of the modulator shows illumination patterns 1012, 1014, 1016, 1018, 1020 for five different individual visible wavelengths with a higher-resolution image of a three-element linear fiber array input at the visible input plane, as imaged by the imaging dispersive element with aberration correction. The Model 1000 shows a clear gap between individual NIR spectral images 1002, 1004, 1006, 1008, 1010 and visible images 1012, 1014, 1016, 1018, 1020.

FIG. 10B illustrates photographs 1030, 1050 of the modulator plane for two measurements of embodiments of a near-IR extended spectral shaper system of the present teaching. The NIR regions 1032, 1052 and the visible regions 1034, 1054 of the modulator for each photograph 1030, 1050 are indicated. Each photograph is illuminated with different input illumination that extends from the visible through the NIR portion of the spectrum. The entire spectrum of illumination for each measurement is shown in the photographs 1030, 1050. The illumination for the entire measured spectrum shares the same imaging dispersive element and all spectral components separated by the dispersive element fall onto the same modulator element. A clear spatial gap is apparent between the illuminated regions 1032, 1034 in the first photograph 1030 and also between the illuminated regions 1052, 1054 in the second photograph 1050. This is necessary to provide independent spectral control for the NIR regions 1032, 1052 and the visible regions 1034, 1054. For modulators that are pixelated modulators with a two dimensional array of pixels, it is clear that the pixels for the NIR region 1032, 1052 are different from the pixels for the visible region 1034, 1054. It is also clear that individual spectral components of the visible and/or the NIR regions are distinct, and also can be independently controlled by controlling different regions of pixels on the pixelated modulator.

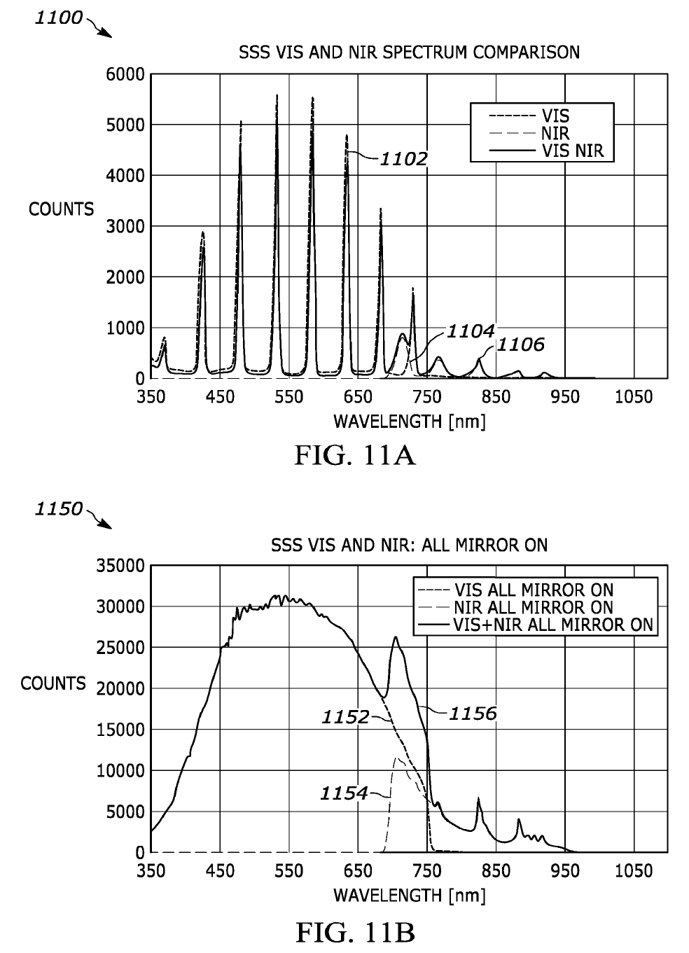

FIG. 11A illustrates a graph 1100 of spectra from an embodiment of the spectral shaper system of the present teaching with rows of mirrors configured in the “on state” showing a comparison of the visible spectrum and the NIR spectrum. The spectral shaper system used for these measurements included a DMD with micro-mirrors as pixels at the modulator plane. These measurements were taken at the output of a liquid light guide that was optically coupled to the output of the spectral shaper system. For this measurement, eight rows of mirrors, with each row having a five-mirror width, was turned on. The visible spectrum 1102 is shown in short, dashed line and the NIR spectrum 1104 is shown in a longer dash line. The combined spectrum 1106 is also shown with a solid line. The eight peaks apparent in the visible spectrum 1102 have a small full width at half maximum (FWHM). Five of the eight peaks of the NIR spectrum 1104 have lower counts and slightly broader FWHM. Some imbalances of the intensity of the spectra in the graph 1100 are due to attenuation in the liquid light guide, which has low transmission for wavelengths greater than 730 nm that collected the output light.

FIG. 11B illustrates a graph 1150 of spectra from the spectral shaper system described in connection with of FIG. 11A showing the output with all the mirrors in the “on state” for the visible spectrum and/or the NIR spectrum. The visible spectrum 1152 with all mirrors in the “on state” in the visible region of the modulator is shown in short, dashed line and the NIR spectrum 1154 with all mirrors in the “on state” in the NIR region is shown in a longer dash line. The combined spectrum 1156 with all mirrors in the “on state” in both regions is also shown with a solid line. With all mirrors in the “on state”, the output exhibits a higher count rate with individual spectral components not distinguished, and the total wavelength range is lower than the rows in on state of graph 1100.

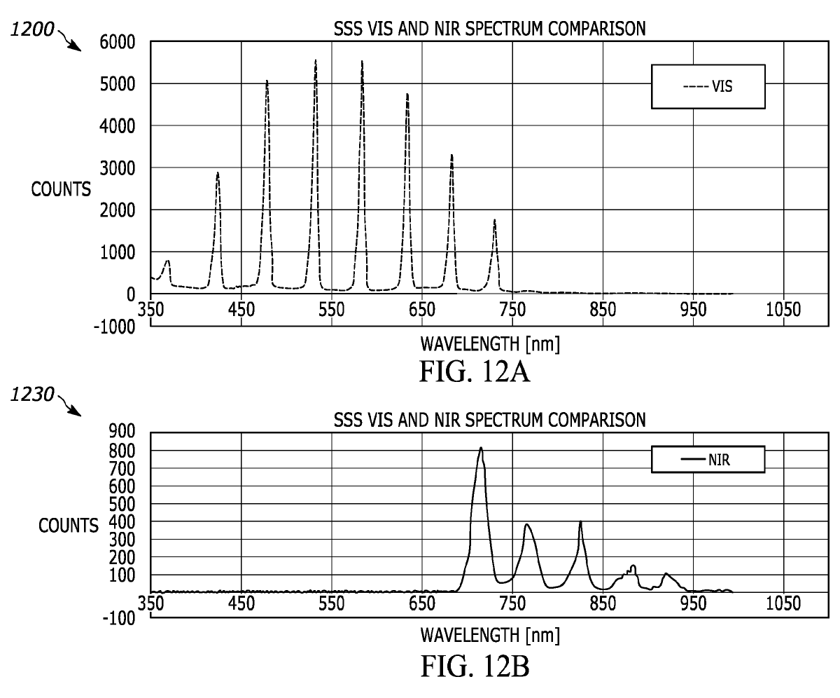

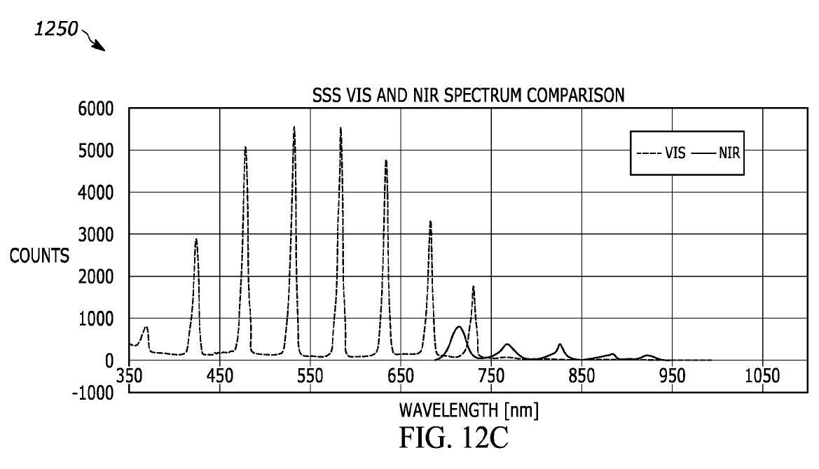

FIG. 12A illustrates a graph 1200 of a spectrum from an embodiment of the spectral shaper system of the present teaching with rows of mirrors in the “on state” in the visible region. This graph shows results with eight rows of five mirror with each mirror in the “on state”. The high resolution provided by the aberration-corrected imaging is illustrated by the small FWHM.

FIG. 12B illustrates a graph 1230 of a spectrum from an embodiment of the spectral shaper of the present teaching with rows of mirrors in the NIR region in the on state. The NIR peaks have a wider FWHM.

FIG. 12C illustrates a graph 1250 of both the visible spectrum and the NIR spectrum of FIGS. 12A and 12B on the same plot. The comparison shows lower throughput for the NIR light, and the larger FWHM. The liquid light guide used for this measurement had low transmission for the NIR region, but extended transmission liquid light guides are available with over 70% transmission throughout the near infrared region. Throughput of the spectral shaping system can be improved by extending the reflectivity of the imaging dispersive device by using, for example, a gold coated reflective surface that can result in as much as 10% higher flux. Also, changes in the aberration condition can modify the tilt of the individual lines in the NIR spectrum.

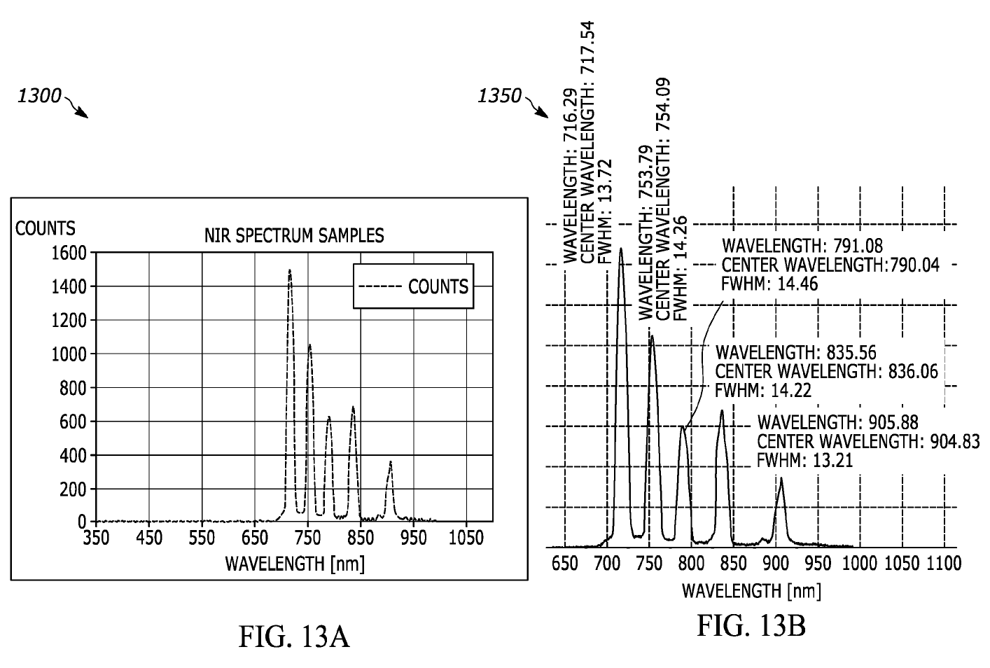

FIG. 13A illustrates a graph 1300 of a spectrum from an embodiment of the spectral shaper system of the present teaching with five peaks in the NIR region using five rows of mirrors in the “on state” in the NIR region. The sample peaks are at 716 nm, 754 nm, 791 nm, 835 nm and 905 nm.

FIG. 13B illustrates a graph 1350 of the spectrum of FIG. 13B with calculated FWHM information. The peak at 716 nm has a FWHM of 13.72 nm. The peak at 754 nm has a FWHM of 14.26 nm. The peak at 791 nm has a FWHM of 14.46 nm. The peak at 835 nm has a FWMH of 14.22 nm. The peak at 905 nm has a FWHM of 13.21 nm. Thus, the FWHM ranges from 13 nm to 14 nm.

One feature of the present teaching is that it is possible to have both the NIR optical source light and the visible source light be generated by the same optical source. The optical source is constructed so that the visible source light is provided at a plane consistent with the visible input plane of the spectral shaper and the NIR source light is provided at a plane consistent with the NIR input plane of the spectral shaper as described herein. One advantage of this embodiment is that both complexity and cost are reduced by using a single source to power both the visible and NIR illumination. This design makes it possible to provide a compact NIR-extended programmable light source using the spectral shaping system.

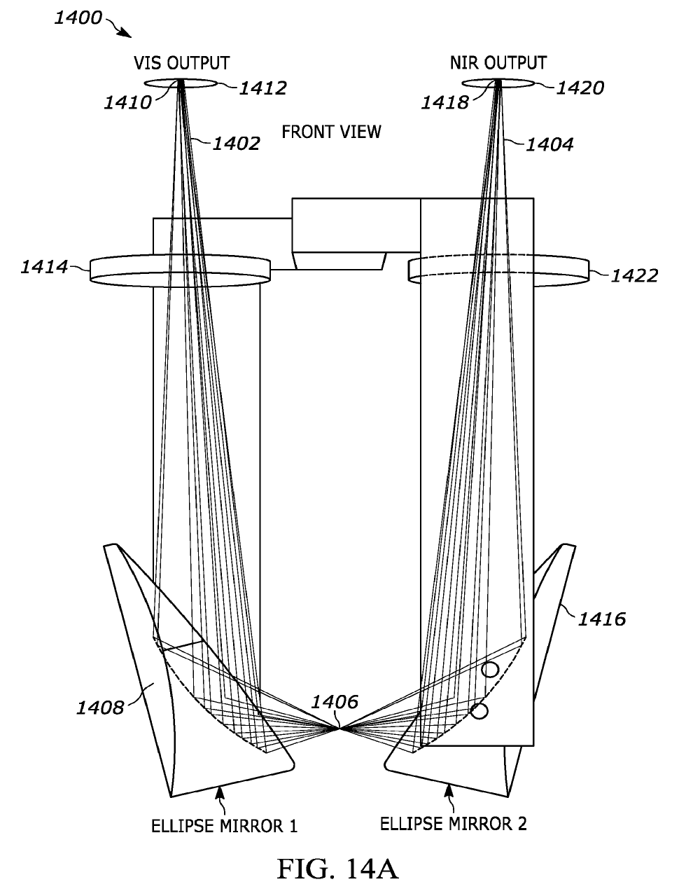

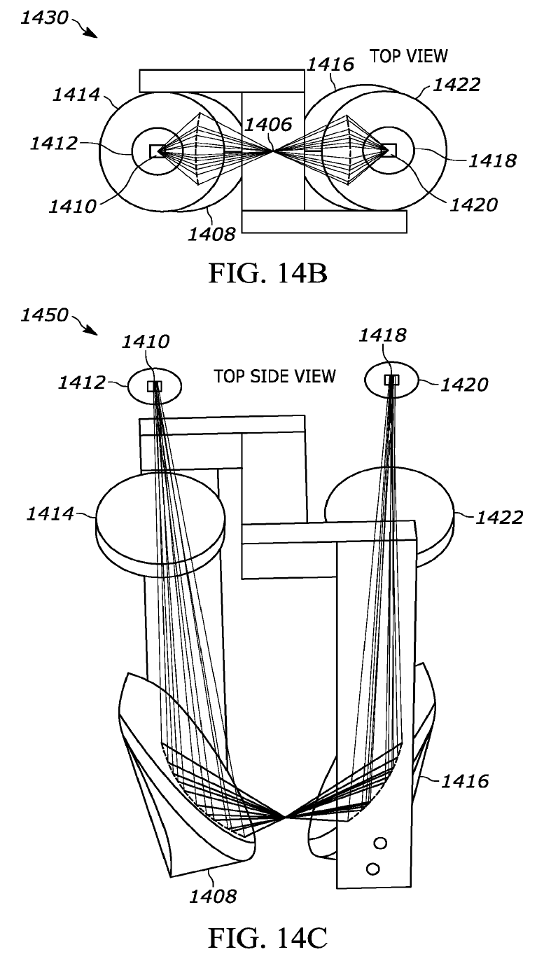

FIG. 14A illustrates a front view 1400 of an optical source that generates visible light 1402 and NIR optical light 1404 from a broadband point source 1406 of light. The broadband point source 1406 of light can be, for example, generated by a high-intensity plasma of a laser driven light source. A first elliptical mirror 1408 reflects and focuses light from the point source 1406 to a visible output 1410 optical beam with a desired shape at a visible output plane 1412. A short pass filter 1414 is positioned in the path of the light reflected from the first elliptical mirror 1408. A second elliptical mirror 1416 reflects and focuses light from the point source 1406 to a NIR output 1418 optical beam with a desired shape at a NIR output plane 1420. A long pass filter 1422 is positioned in the path of the light reflected from the second elliptical mirror 1416. The shape of the visible output 1410 and the shape of the NIR output 1418 is elliptical, which, when coupled into the spectral shaper, serves to balance and smooth the spectrum of the visible and NIR parts of the spectrum at the shaper output.

FIG. 14B illustrates a top view 1430 of the optical source that generates visible light 1402 and NIR optical light 1404 of FIG. 14A. The first and second elliptical mirrors 1408, 1416, short-pass filter 1414 and long pass filter 1422 are shown as well as the visible output plane 1412 and the NIR output plane 1420.

FIG. 14C illustrates a side top view 1450 of the optical source that generates visible light 1402 and NIR optical light 1404 (FIG. 14A). The first and second elliptical mirrors 1408, 1416, short-pass filter 1414 and long pass filter 1422 are shown as well as the visible output plane 1412 and the NIR output plane 1420.

In various embodiments, the relative flux from the visible and NIR optical illumination can be achieved based on the reflectivity of various components used in the source. For example, it is possible to have nominally the same flux level for each channel of visible and/or NIR light. It is also possible to have higher flux in either the visible or the NIR regions. For example, using gold coating on reflective surfaces increases reflected flux of the infrared light. For example, a long-pass filter can flatten the Xenon spectrum response, reducing the peaks of Xenon spectrum in the near infrared. These two aspects can help improve the balance of the NIR part of the spectrum, especially as compared to the visible part of the spectrum of the output light of the optical source. For the visible light path, some embodiments use a first elliptical mirror 1408 with an enhanced aluminum coating and a short pass filter 1414 with a cutoff at 760 nm. For the NIR light path, some embodiments use a second elliptical mirror 1416 with an enhanced gold coating and a long-pass filter 1422 with a cutoff at 740 nm wavelength.

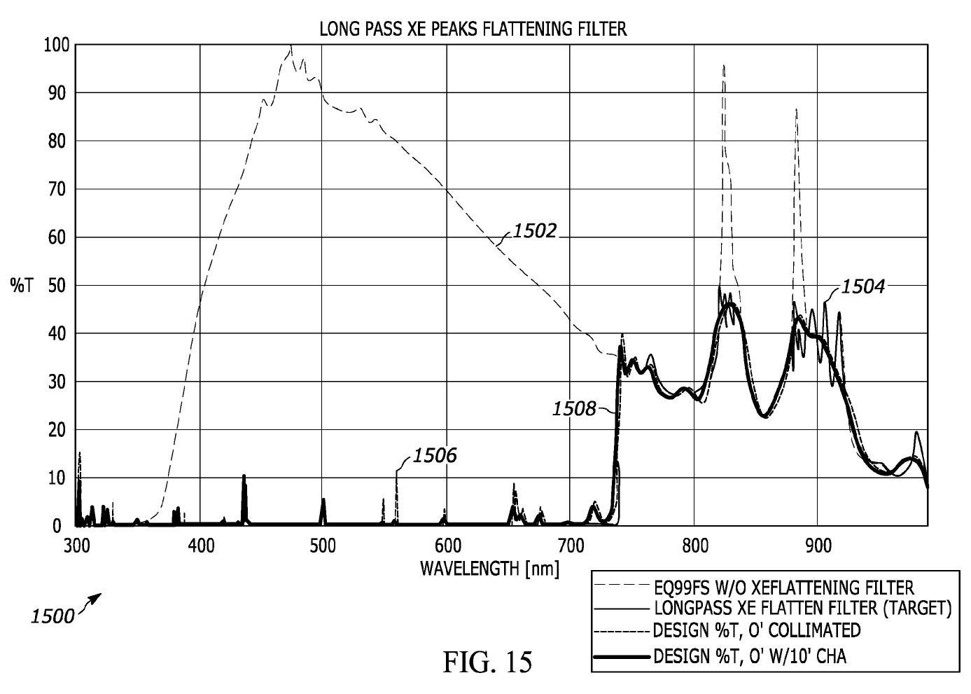

FIG. 15 illustrates a graph 1500 of spectra of the output for different embodiments of the optical source for a spectral shaper system of the present teaching that use different filters and/or mirror coatings on the optical elements and a Xenon-based high-brightness plasma to generate the point source illumination. The first spectrum 1502 illustrates the output of the Xenon plasma, with high peaks in the near infrared region. The second spectrum 1504 illustrates the reduction of the NIR peaks using a long pass Xenon spectrum flattening filter with a cutoff wavelength of 740 nm.

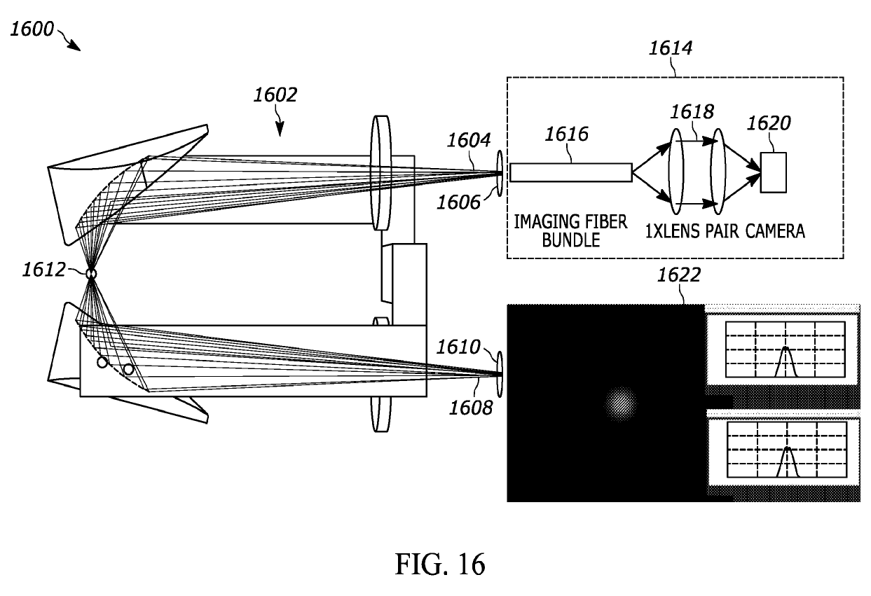

FIG. 16 illustrates an alignment and characterization system 1600 for an optical source 1602 for the spectral shaper system of the present teaching. An optical point source 1612 generates visible light 1604 at a visible output plane 1606 and NIR optical light 1608 at a NIR output plane 1610 from the optical point source 1612. The optical point source 1612 for this embodiment is a high-intensity Xenon plasma driven by a laser. The visible light 1604 at a visible output plane 1606 and NIR optical light 1608 at a NIR output plane 1610 have nominally elliptical shapes. The visible light 1604 or the NIR light 1608 is coupled into an alignment tool 1614 that includes an imaging fiber bundle 1616 and a one-times magnifying lens pair 1618 that images the bundle onto a camera 1620. A position of either the visible beam or the NIR beam on the camera is used to adjust the respective elliptical mirrors. As an example, if the optical point source 1612 has a plasma size of between 80 to 240 micrometers, it is imaged by a three-factor ellipsoidal mirror to a size between 240 and 720 micrometers at the output planes 1606, 1608. The inset picture 1622 shows a point source generated by an optical fiber as imaged at the camera to show the operation of the alignment tool 1614 in an ideal case.

### Equivalents

While the Applicant’s teaching is described in conjunction with various embodiments, it is not intended that the Applicant’s teaching be limited to such embodiments. On the contrary, the Applicant’s teaching encompasses various alternatives, modifications, and equivalents, as will be appreciated by those of skill in the art, which may be made therein without departing from the spirit and scope of the teaching.

What is claimed is:

1. A spectrally-shaped source comprising:
a) an optical source that generates an optical beam having a round shape;
b) an optical element positioned in a path of the optical beam, the optical element transforming the round shape of the optical beam into a rectangular shape;
c) an image forming dispersive device positioned in the path of the optical beam after the optical element, the image forming dispersive device angularly dispersing wavelengths of the optical beam in a dispersion direction and imaging the rectangular shape of the optical beam at a modulation plane;
d) a pixelated spatial light modulator positioned in the modulation plane, the pixelated spatial light modulator comprising an array of pixels that are illuminated by the angularly dispersed wavelengths of the rectangular optical beam imaged by the image forming dispersive device such that each column of illuminated pixels in the array of pixels is illuminated by a different spectral segment of light;
f) a controller having an output that is electrically connected to a control input of the pixelated spatial light modulator, the controller being configured to instruct the pixelated spatial light modulator to reflect the selected portion of the optical beam toward the toroidal optic and to reflect another portion of the optical beam away from the toroidal optic so as to provide a desired spectral shape of the output optical illumination.

2. The spectrally-shaped source of claim 1 wherein the optical source comprises a laser driven light source.

3. The spectrally-shaped source of claim 1 wherein the optical source comprises a super continuum fiber laser.

4. The spectrally-shaped source of claim 1 wherein the image forming dispersive device comprises a single optical element.

5. The spectrally-shaped source of claim 1 wherein the toroidal optics comprises a single optical element.

6. The spectrally-shaped source of claim 1 wherein the optical element comprises a multi-strand fiber bundle having a circular shaped input bundle cross section and a rectangular shaped output bundle cross section.

7. The spectrally-shaped source of claim 1 wherein the image forming dispersive device is configured to provide aberration correction of the spectrally-shaped source.

8. The spectrally-shaped source of claim 1 wherein the pixelated spatial light modulator comprises a digital micromirror device.

9. The spectrally-shaped source of claim 1 wherein the pixelated spatial light modulator comprises a liquid crystal device.

10. The spectrally-shaped source of claim 1 wherein the controller is further configured to use at least one preloaded spectrum file to determine a number of pixels that is chosen to reflect the selected portion of the optical beam toward the toroidal optic.

11. The spectrally-shaped source of claim 1 wherein the controller is further configured to instruct the pixelated spatial light modulator to reflect the selected portion of the optical beam toward the toroidal optic so that at least two columns of pixels in the array of pixels are illuminated at a same height.

12. The spectrally-shaped source of claim 1 wherein the controller is further configured to instruct the pixelated spatial light modulator to reflect the selected portion of the optical beam toward the toroidal optic so that so that a desired spectral shape of the output optical illumination at the output is provided.

13. The spectrally-shaped source of claim 1 further comprising a liquid light guide optically coupled to the output of the spectrally-shaped source.

14. The spectrally-shaped source of claim 1 further comprising a spectral extension source that generates light in a desired spectrum and an optical coupler that couples the generated light in the desired spectrum to the output of the spectrally shaped source.

15. The spectrally-shaped source of claim 14 wherein the spectral extension source comprises one or more NIR LED.

16. The spectrally-shaped source of claim 1 further comprising a second-order elimination filter positioned between the imaging dispersive device and the pixelated spatial light modulator.

17. The spectrally-shaped source of claim 16 wherein the second-order elimination filter is configured to block a short-wavelength spectral component and to pass a long-wavelength spectral component.

18. The spectrally-shaped source of claim 1 wherein the pixelated spatial light modulator further comprises an order-sorting filter.

19. A method of spectrally shaping, the method comprising:
a) generating an optical beam having a round shape;
b) transforming the round shape of the optical beam into a rectangular shape;
d) spatially modulating the dispersed and imaged optical beam using a pixelated spatial light modulator comprising an array of pixels such that a column of pixels in the array of pixels is illuminated by one of the plurality of spectral segments of light so that the pixelated spatial light modulator reflects a desired selected portion of the optical beam toward toroidal optics; and
e) projecting the selected portion of the optical beam with the toroidal optics to an output.

20. The method of claim 19 wherein the spatially modulating is performed with a controller using predetermined control information.

21. The method of claim 19 wherein the spatial modulating is performed to reflect the desired selected portion of the optical beam toward the toroidal optic so that at least two columns of pixels in the array of pixels are illuminated at a same height.

22. The method of claim 19 wherein the spatial modulating is performed so that a desired spectral shape of the output optical illumination is provided.

23. The method of claim 19 further comprising coupling light from a spectral extension source with a desired spectrum to the output.

24. The method of claim 23 wherein the desired spectrum is in the near infrared region of the spectrum.

25. The method of claim 19 further comprising filtering the dispersed and imaged optical beam.

26. The method of claim 25 wherein the filtering comprises blocking a short-wavelength spectral component and passing a long-wavelength spectral component.
